(19) United States
(12) Patent Application Publication
(10) Pub. No.: US 2009/0008109 A1
(43) Pub. Date: Jan. 8, 2009

(54) DRAG MAT

(75) Inventor: Randall Craig Paulson, Maple Grove, MN (US)

Correspondence Address: SCHWEGMAN, LUNDBERG & WOESSNER, P.A., P.O. BOX 2938, MINNEAPOLIS, MN, 55402, US

(73) Assignee: Par Aide Products Co., Lino Lakes, MN (US)

(21) Appl. No.: 12/163,354

(22) Filed: Jun. 27, 2008

Related U.S. Application Data
(60) Provisional application No. 60/937,720, filed on Jun. 29, 2007.

(51) Int. Cl. A01B 35/00

(52) U.S. Cl. 172/612

(57) ABSTRACT

A modular drag mat system.

### CROSS-REFERENCE TO RELATED APPLICATIONS

This application claims the benefit under 35 U.S.C. 119 (e) of U.S. Provisional Application No. 60/937,720, filed on Jun. 29, 2007, which is hereby incorporated by reference in its entirety.

### FIELD OF THE INVENTION

This invention relates to the field of turf maintenance, and more specifically to a drag mat.

### BACKGROUND

The greens and fairways on a golf course are sometimes aerated to improve the growth of grass. Aerating results in plugs of earth that litter the surface of the turf. These plugs can be difficult to remove.

### BRIEF DESCRIPTION OF THE DRAWINGS

FIG. 1 shows a drag mat, in accordance with one embodiment.

FIG. 2 shows the drag mat of FIG. 1 as used on a golf course, in accordance with one embodiment.

FIG. 3 shows another view of the drag mat of FIG. 1 in use.

### DETAILED DESCRIPTION

In the following detailed description, reference is made to the accompanying drawings which form a part hereof, and in which is shown by way of illustration specific embodiments in which the invention may be practiced. These embodiments are described in sufficient detail to enable those skilled in the art to practice the invention, and it is to be understood that other embodiments may be utilized and that structural changes may be made without departing from the scope of the present invention. Therefore, the following detailed description is not to be taken in a limiting sense, and the scope of the present invention is defined by the appended claims and their equivalents.

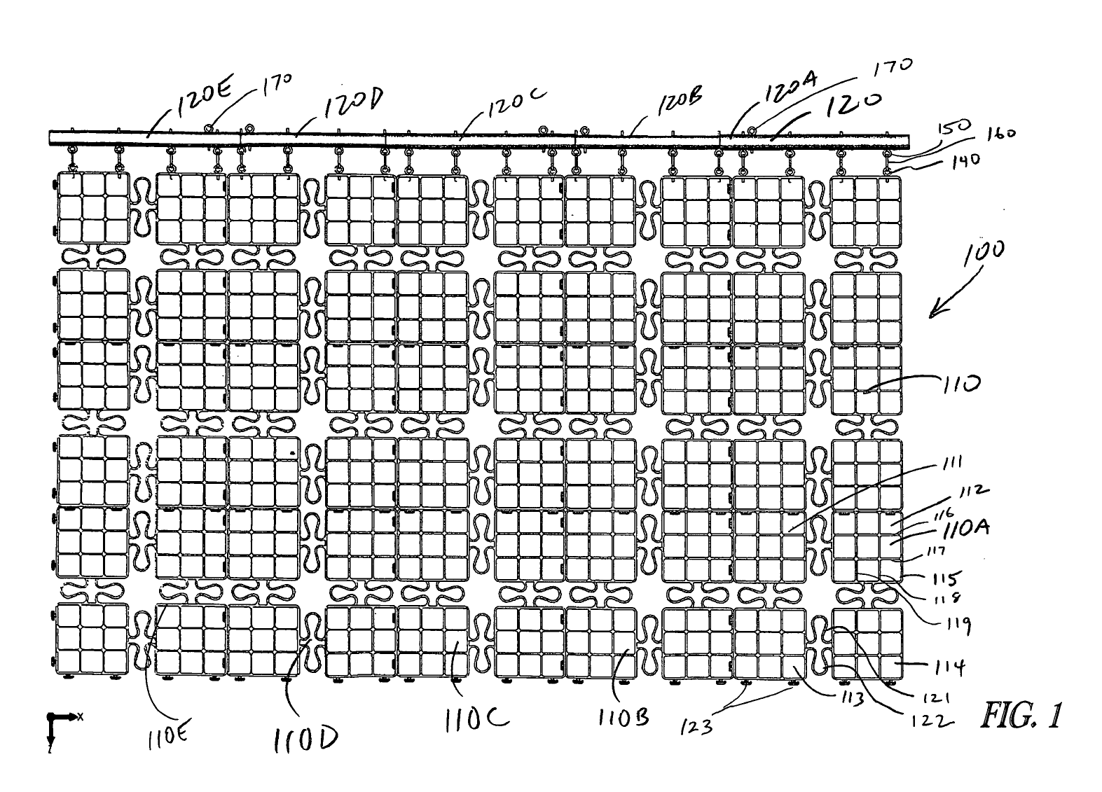

FIG. 1 shows a drag mat system 100, in accordance with one embodiment. Drag mat system 100 generally includes a drag mat 110 and a drag bar 120. Drag bar 120 is attached to drag mat and then connected to a tractor for pulling the drag mat over the ground.

Drag mat 110 is formed from a plurality of similar modular drag mat elements 110A, 110B, 110C, 110D, 110E, etc. Any number of drag mat elements can be configured to be assembled into a drag mat 110 of variable size. The present example shows a drag mat 110 having a 5×3 configuration. Since the drag mat elements can be configured in virtually any fashion the drag mat 110 can be 5×1, or 4×2, or 8×3, or virtually any other configuration. In some embodiments, the drag mat elements can be configured such that the drag mat 110 is not a rectangular shape. For example, it can be L-shaped, C-shaped, or whatever is desired by the user.

Drag bar 120 is formed from a plurality of modular drag bar members 120A, 120B, 120C, 120D, and 120E, etc. The drag bar members are configured to be assembled into a drag bar 120 of variable size, depending on the desired size of the drag mat. For example, each drag bar member can include one end having a reduced diameter, allowing it to fit within an end of a second drag bar member, and so on.

In one embodiment eye-hooks 140 can be attached to the top row of drag mat elements and each drag bar member can include corresponding eye-hooks 150. The mat elements can be attached to the drag bar members using hooks 160, such as carabineers, for example. Drag bar 120 further includes eye-hooks 170 to attach to one or more cords for pulling the drag mat.

In one example, each of drag mat elements 110A, 110B, 110C, 110D, 110E have a similar structure and drag mat element 110A will be described. Drag mat element 110A includes a structure comprising a generally square main structure with four square shaped elements 111, 112, 113, and 114 located at each quadrant of the main structure. Each of the four square shaped elements 111, 112, 113, and 114 include an outer perimeter wall 115 and four inner walls 116, 117, 118, and 119 configured to define nine inner squares within each square shaped element. Adjoining square shaped elements such as elements 113, 114 are connected by flexible bent arms 121, 122. Each element includes clip members 123 along one or more sides of the square element. Each element also includes grooves or slots on the bottom surface of the element to mate with the clip members 123 of adjacent elements. Clip members 123 engage the side edge slots of adjacent elements to allow as many elements 110A, 110B, 110C, 110D, 110E, etc. to be attached together to form a drag mat of any desired size or shape. In one example, drag mat elements 110A, 110B, 110C, 110D, 110E, etc can be Schwabengitter® turf grids.

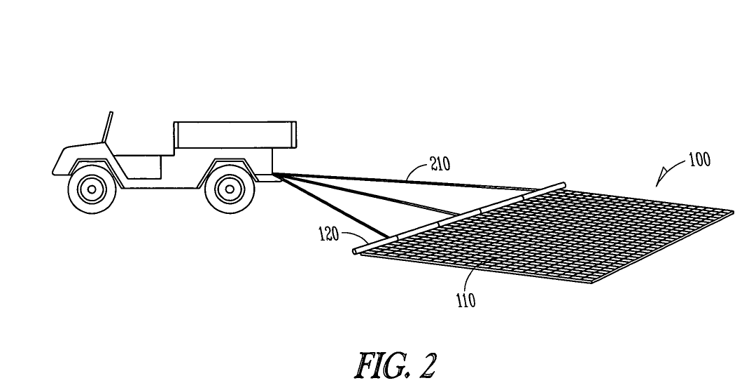

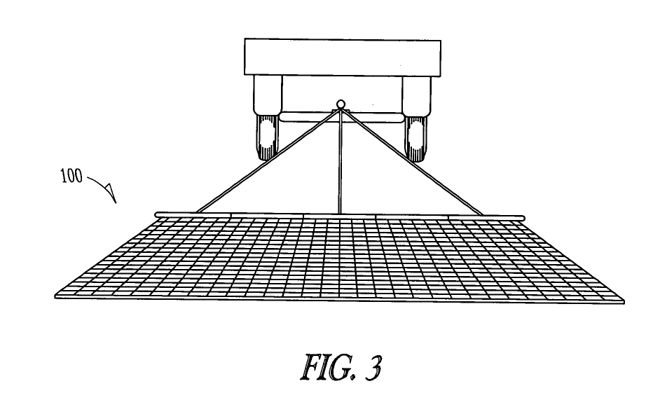

FIGS. 2 and 3 show drag mat system 100 as used on a golf course, for example. The drag mat 110 is put together as discussed above from the modular drag mat elements. The drag bar 120 is also assembled into the desired length so that it is long enough to extend across the length of the assembled drag mat 110. The drag bar 120 is attached to the drag mat 110 and one or more cords 210 are attached to drag bar 120 to allow for dragging the mat utilizing a tractor, for example. The drag mat 110 breaks apart the turf plugs so that the plugs are broken down.

It is understood that the above description is intended to be illustrative, and not restrictive. Many other embodiments will be apparent to those of skill in the art upon reviewing the above description. The scope of the invention should, therefore, be determined with reference to the appended claims, along with the full scope of equivalents to which such claims are entitled.

1. A drag mat system comprising:
a drag mat; and
a plurality of modular drag bar members configured to be assembled into a drag bar of variable size;
wherein the drag bar is attached to the drag mat.

2. The drag mat system of claim 1, wherein the system includes at least four modular drag bar members.

3. (canceled)

4. A method comprising:
assembling a modular drag mat system including assembling a modular drag bar and attaching the drag bar to a drag mat; and
pulling the drag mat over ground.

5. The method of claim 4, wherein the modular drag bar includes at least four modular drag bar members.

6. (canceled)
